(19) United States
(12) Patent Application Publication
(10) Pub. No.: US 2004/0139866 A1
(43) Pub. Date: Jul. 22, 2004

(54) Method and system for treating and shaping drill cuttings leaving the well bore for transportation and/or disposal of drill cuttings

(76) Inventor: Perry Lopez, Lafayette, LA (US)

Correspondence Address: GARVEY SMITH NEHRBASS & DOODY, LLC, THREE LAKEWAY CENTER, 3838 NORTH CAUSEWAY BLVD., SUITE 3290, METAIRIE, LA, 70002

(21) Appl. No.: 10/348,105

(22) Filed: Jan. 21, 2003

(51) Int. Cl. B65B 13/00; B02C 17/00; B02C 17/02

(52) U.S. Cl. 100/7

(57) ABSTRACT

A method of treating and shaping drill cuttings for disposal, which includes the steps of providing initial separation of drilling fluid from the drill cuttings after the drilling fluid is returned from the borehole; drying the drill cuttings in a cuttings dryer; shaping the cuttings into pellets; granulating the cuttings pellets into granular material; and conveying the granulated cuttings for transport to an onboard bulk storage boat or to a dockside cuttings disposal site, so that the drill cuttings entering the cuttings dryer contain 20% to 40% or more of oil on cuttings (OOC) ratio of drilling fluids retained on the drill cuttings, while the cuttings are dried in the cuttings dryer have a moisture content of 1% to 8% total moisture. Next the cuttings are formed into highly compressed, spherical pellets, so that the pelletized cuttings can be transported more readily, and free of hydrocarbon cross-contamination during storage. Solids control equipment separates the cuttings from the drilling fluid returning from a drill string, while the drilling fluid portion is returned unladen with cuttings down into the drill string. There is provided a cuttings dryer for reducing the moisture content of the cuttings to a range of 1% to 8% total moisture and a pelletizer for pelletizing the cuttings so that the cuttings are formed into highly compressed, pellets substantially free from cross-contamination for safe transport and storage.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

1. Field of the Invention

The present invention relates to the treatment of oil and gas well drill cuttings. More particularly, the present invention relates to a method and system for treating drilled earthen solids “drill cuttings” generated in the oil and gas exploration process to reduce surface moisture and to produce a predictable shape, size and form of the drill cuttings that have been removed from the well bore in order to be conveyed from a drilling vessel, for shipping or transporting purposes for final disposal.

2. General Background of the Invention

Since the introduction of oil phase drilling fluids it has been a difficult environmental issue of treating and handling oil contaminated drilled solids. The advantages of using an oil phase fluid outweigh the environmental and economic concerns for their use.

Oil was first used for water and oil drilling in the early 1900's as asphalt or coal tar to provide a viscous medium to remove cuttings from the bore hole. The use of commercial clays in water based drilling fluid precluded the use of “oil mud” until the 1950”s. Specific research was started in the 1930's and 40's to overcome deficiencies in utilizing oil as a drilling fluid, namely:

Lack of gel structure: This was solved by the discovery and use of organophillic clays.

Lack of viscosity control/suspension: Addressed by the development of emulsifiers, wetting agents, and thinners which are undergoing continuous modification as the selection of base oils and environmental regulation increases.

Volatile components: Emulsifier improvements allow oil muds to drill with up to 40% water content, significantly reducing flash points.

Scientific advances enabled oil based drilling fluid to become an economic alternative to water based fluid, and more cost effective in the following areas.

High temperature stability: Oil muds can be formulated for temperatures in excess of 500 degrees.

Lubricity: Oil muds have inherently low frictional co-efficients, which is especially useful in horizontal and extended reach drilling.

Stuck pipe prevention: The low oil filtrate and excellent lubricity characteristics aid in reducing differential sticking in highly permeable formations and high angle holes.

Down hole contamination: An oil mud will not dissolve water soluble formations such as salt or gypsum; also provides stability from acid gas bearing formations.

Corrosion resistance: The nonconductive, external phase of an oil mud prevents maximum protection for drill pipe and casing.

Production protection: The permeability of producing sands is not reduced since the oil filtrate will not cause swelling and dispersion of hydratable clays that are in the pores of he sand.

Borehole/shale stability: This performance advantage is the most significant because borehole stability is the number one reason given for oil mud selection.

Water based fluids can be engineered to perform (or out-perform if environmental factors/expense warrant) as well as oil based drilling fluid in all areas but shale stability. Hydrating shale, which makes up 75% of most marine dispositional basins, is the main cause of lost hole and down hole drilling problems. Marine shale is composed of clays containing smectites and illites. Although illite is not as active (expanding, swelling) as the smectite group, illite will expand or destabilize over time. Oil based drilling fluid, with oil as the continuous phase and water tightly emulsified as droplets, does not provide a hydrating medium for the active clay content of marine shales.

The obvious advantages of preventing shale hydration are:

Drilling rates: So dramatically increased that the limitation is surface handling equipment for cuttings and annular loading (hole cleaning).

Competent Borehole: Reduced incidence of lost hole and minimal wash-out means an economic advantage in terms of lowered volume of treated mud, and reduced volume of cuttings for disposal.

These two reasons alone translate into tens of millions of dollars in savings. So, with such assets evident in oil based drilling fluid, what are the disadvantages? Oil, of any kind, is unacceptable discharge into a marine environment. Although cuttings with oil retention of 6-9% are allowed in the Gulf of Mexico and Canada (North Atlantic), the North Sea is under zero discharge regulations with the Gulf of Mexico sure to follow suit. Controlling costs associated with disposal and handling of oil based mud and cuttings are and will continue to be a major factor in engineering and costing a drilling fluid system.

Down hole fluid losses:

Because oil based drilling fluid does not deposit an impermeable filter cake across porous/permeable formations, whole mud loss down hole is an expense that must be considered. Poor hole cleaning in deviated holes can result in un-remedial formation fractures due to “spiking” circulating pressure. Expensive rig time and whole mud losses due to such an event are considerable and pressure depleted zones may require additional casing strings in order to reach planned depth. Nevertheless, oil phase drilling fluid will continue as a major player when expensive rig time outweighs other factors.

In a rotary drilling operation, a drilling fluid is circulated from a fluids storage area “mud pits” on the surface of the drilling vessel, downward through the drill pipe, out apertures in the drill bit, and upward within the borehole to the surface. This return drilling fluid carries with it the drill cuttings from the bottom of the borehole. The returning drilling fluid along with its entrained drill cuttings is flowed into the “solids control equipment’, i.e. gumbo chains, shakers, d-sanders, d-silters, cuttings dryers and centrifuges but not limited before it is returned to the fluid storage area. The solids control equipment, which normally sits above the mud storage area, is essentially a system that is used to separate the drill cuttings and earthen solids from the drilling fluids.

Disposal of these separated cuttings is problematic to meeting environmental regulations established by federal and state governing environmental agencies. When a drilling fluid system such as an oil-phase fluid system is used which coats the cuttings with an oily residue contaminant, i.e., hydrocarbons, (oil phase, synthetic or ester base). The cuttings cannot be disposed of directly without additional treatment to meet regulatory guide lines. In some case regulatory guidelines prohibit the discharge of the drilled cuttings to environment and are required to be shipped to shore.

Industry and Regulatory techniques for treating these contaminated cuttings to make them ecologically acceptable are mechanically dried of the oil laden cuttings or containerizing and shipped to shore. Current regulations mandated an Oil On Cuttings “OOC” discharge limitation to 6.9% for discharge into offshore waters.

In certain areas there is a “Zero Discharge” limit whereby oil contaminated drilled cuttings are containerized and shipped to shore for further disposition.

The Information Disclosure Statement filed herewith provides reference to prior art found as a result of a patentability search conducted on the invention.

### BRIEF SUMMARY OF THE INVENTION

The process and apparatus of the present invention solves the problems confronted in the art in a simple and straightforward manner. More particularly, the process is to include a pre-treatment process of the drill cuttings once they have been removed from the solids control equipment and is to be further processed through a mechanical drying mechanism or the like, reducing liquid content on the drill cuttings and further processed through a pelletizing/briquetting process. The shaped cuttings are to be granulated in a dry form that will allow for further material handling of a known shaped product. Further to the handling of the shaped cuttings they may be pneumatically or mechanically conveyed in a dry form to on-board storage, i.e bulk storage containers cuttings boxes or the like and then conveyed to a vessel for transport to shore in the bulk container holds or cuttings boxes or the like on of the work boats. Since the cuttings are in a dry form there will be no cross contamination of storage containers and inherent problems with wet cuttings are avoided.

The advantages of the process include, but are not limited to:

Recovery of expensive drilling fluids otherwise lost to the environment;

Utilizes existing on-board support equipment i.e. bulk storage tank, or acceptable storage containers, pneumatically or mechanically conveying systems;

Personal Safety;

Reduced cost of processing and transfer equipment;

Volumetric reduction of drilled cuttings being returned to shore for disposal into the environment;

Significant reduction in clean-up costs by reducing cross contamination of storage and shipping vessels;

Reducing cost on specialty storage/shipping containers

Reduced personal exposure to moving storage/shipping containers in a hostile offshore environment;

Reduced cost and time to remove dried shaped cuttings from storage vessels;

Reduced costs for disposal of dried cuttings into an approved disposal facility; and

Reduced cost of processing dried shaped cuttings through thermal facilities.

### BRIEF DESCRIPTION OF THE SEVERAL VIEWS OF THE DRAWINGS

For a further understanding of the nature, objects, and advantages of the present invention, reference should be had to the following detailed description, read in conjunction with the following drawings, wherein like reference numerals denote like elements and wherein:

FIG. 1 illustrates a schematic flow diagram of the preferred embodiment of the process of the present invention.

### DETAILED DESCRIPTION OF THE INVENTION

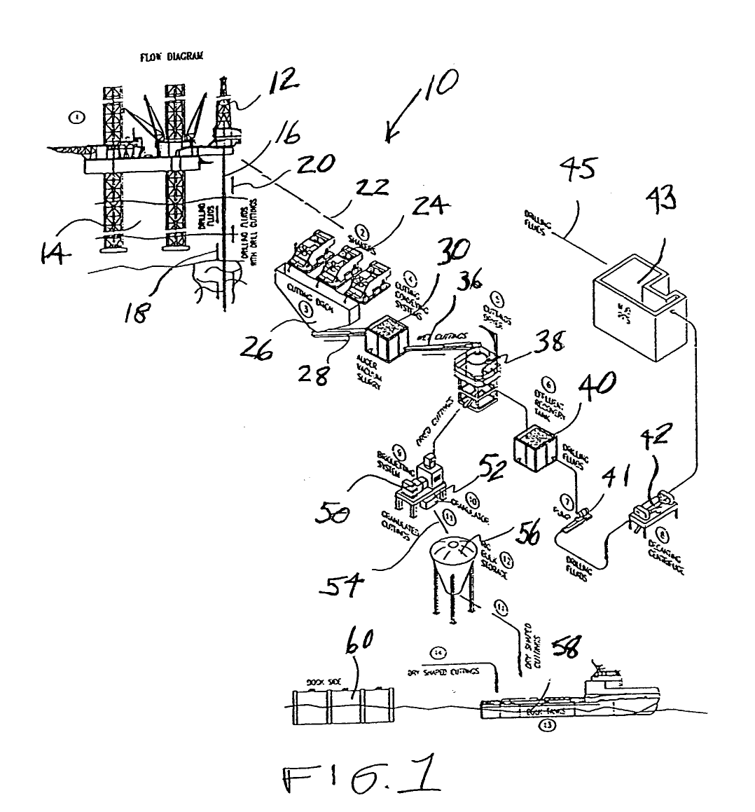

Initially, reference is made to FIG. 1, which illustrates schematic flow diagram of the preferred embodiment of the process of the present invention by the numeral 10. As illustrated, process 10 includes a drilling rig 12 positioned in a body of water 14, with a drill pipe 16 extending into the earth below the body of water 14 drilling for hydrocarbons, such as oil or natural gas. During the process, the drilling fluids are circulated down into the borehole in the direction of arrow 18, and then are returned up the annulus of the borehole, in the direction of arrow 20, carrying the drill cuttings for treatment and disposal.

The drilling fluid containing the drill cuttings are routed first, via line 22, to the standard rig solids control equipment and shakers 24, in order to undergo the initial separation of the solid cuttings from the drilling fluid. The cuttings flow via gravity to the lower end 26 of the equipment to be received into a cuttings ditch or trough 28. The cuttings are conveyed to a cuttings conveying system 30, which would normally comprise augers, vacuum system, and a slurry system, all provided in order to provide greater separation between the cuttings and the drilling fluid, which would be returned downhole for further use.

Next, the wet cuttings which are being conveyed from the conveying system 30 would be conveyed via conveyer 36 to a cuttings dryer 38, which may be either a vertical or horizontal cuttings dryer 38, depending on the circumstances. The effluent from the cuttings dryer 38 would be conveyed to an effluent recovery tank 40, where the drilling fluids or effluent would then be pumped via pump 41 from the tank 40 into a decanting centrifuge 42. The drilling fluids, after being routed through the centrifuge 42 would then be returned to the mud pits 43 for returning the processed drilling fluid via return line 45 to the drill pipe 16, containing no cuttings, back down the borehole to pick up additional cuttings.

During the process, as the drilling fluids leave the cuttings dryer 38, the dried cuttings which are dried in the cuttings dryer 38 are convey to the briquetting system 50, of the type manufactured by K-R. Komarek, and then to the granulating system 52, of the type which is manufactured by numerous manufacturers, and is well known in the granulating art, in order to granulate the cuttings for their being conveyed from the granulating system 52 via the rig pneumatic conveying system 54, to the rig bulk storage area 56 on the rig. The granulated cuttings stored in the area 56 would then be conveyed to a onboard boat bulk storage area 58, or may be conveyed to a dockside storage area 60 for final disposition of the cuttings on land.

Discussing the process and the apparatus in more detail, during rotary drilling operation, and continuing to reference FIG. 1, the drilling fluid is circulated from a drilling fluids storage area “mud pits” 43 on the surface of the drilling vessel, downward through the drill pipe 16, out apertures in the drill bit, and upward within the borehole to the surface. The drill bit cuts the earthen formation creating earthen shavings (drilled cuttings) that are picked up by the drilling fluid. This return drilling fluid (arrow 20) carries with it the drill cuttings from the bottom of the borehole. The returning drilling fluid along with its entrained drill cuttings are flowed into the “solids control equipment’, i.e. gumbo chains, shakers, d-sanders, d-silters 24, cuttings dryers 38 and centrifuges 42, but not limited thereto, before it is returned to the mud pits 43.

The solids control equipment 24, which is typically situated above the mud storage area, is essentially a procedure that is used to separate the drill cuttings and earthen solids from the drilling fluids. Drilling fluid that have been returned from down hole have liquid to solids ratios that can range between 40-80% liquid with the balance being drilled solids.

Once the solids control equipment 24 has processed the drilled cuttings, removing the majority of the drilling fluid they flow into a feed hopper “cuttings ditch” 28 or the like for collection purposes. The processed cuttings typically will have on average of 20-40+-% oil on cuttings “OOC” ratio of drilling fluids retained on the drill cuttings once processed through the solids control equipment 24.

There are various collections and conveying systems that are employed within the industry in the transportation of the fluid laden drill cuttings, i.e. augers, vacuum collection, and slurring systems, but not limited thereto, that are used to move the fluid laden drill cuttings. When the drilled cuttings have processed through the conveying system 36, the fluid laden drill cuttings are further processed through a mechanical drying system 38 that may be in a vertical or horizontal disposition, i.e “cuttings dryer”, that will further reduce the oil on cuttings “OOC” and total moisture content ratio downward to 1.0% but not limited to 8.0%. Reducing the OOC serves two purposes within the process. First by reducing the fluids content on the cuttings you return an expensive resource for reuse in the drilling application and further reduce potential contaminants entering back into the environment.

The dried cuttings having an average of 1-8% total moisture content containing hydrocarbons and fluids are conveyed from the cuttings dryer to the briquetting/pelletizing process or system 50, as stated earlier of the type manufactured by K-R. Komarek. The terms “briquetting” and “pelletizing” may be used interchangably in this application. Both briquetting or pelletizing would be defined as an agglomerations process whereby an amorphous mass of finely divided particulates, such as dust, powder, fume, is formed into a pellet, a ball or a granule in the presence of moisture. If required for increased product hardness or process considerations, a solid or liquid binder can be added before or during pelletizing.

As fines are moistened and rolled in an inclined, rotating drum or disc pelletizing apparatus, loose pendular funicular and capillary bonds are formed between the grains of the material, causing nucleation into small seeds and gradual growth by packing, densification and layering, as a dense solids bond replaces the loose solids-air-water-bond with a moisture film between particles. As more fines are continuously fed into the pelletizer, spherical pellets of proper size are discharged over the edge of the drum or pan, while smaller pellets and growing seeds are retained in the bottom. The pressure required to form the drill cuttings into pellets or briquettes may be in the range of 7500 to 65,000 psi, preferably, for off shore applications, at a range of 55,000 but not limited to 65,000 psi.

Pellet size is controlled by the angle and speed of the pelletizer, placement of the feed and location of the water sprays, as well as the amount of liquid added at any given location. Thus the retention time and availability of dry fines and moisture can be controlled. The pellets are uniform in size due to natural classification action of the pelletizer. Sizing and forming the dried cuttings under pressure through the process allow the drilled cuttings to become a predictable material to deal with in a dry form.

During the formation of the spherical pellets under pressure the hydrocarbon laden cuttings are compressed into a state that is no longer sticky or tacky to the touch as with the raw drill cuttings. The significance of the high pressure compression during the briquetting phase on the cuttings allows, that the hydrocarbon contained in the cuttings prevents the potential of cross contamination of storage containers.

Following the formation of the cuttings into briquettes, the briquettes are then reduced to a granular form through the use of a granulator 52, again a system which is well known in the art. The granulator 52 reduces the briquettes to irregular shaped particles, having a particle size in the range of −5 microns but not limited to +50 microns, at least to a size, which will enhance the granules capability to be convey pneumatically, due to their small size and lack of surface moisture.

When the drill cuttings are formed into granules, they can be conveyed onboard the drilling vessel using the drilling rig on board pneumatically or mechanically conveying system 54 or the like to moved the processed cuttings in a dry form to onboard bulk storage 56 similar to cement or barite or the like. With dried cuttings processed and formed there are no free hydrocarbons on the cuttings to cause cross-contamination in the onboard bulk storage system.

From the onboard bulk storage containers 58 the formed dry cuttings can be conveyed to onboard bulk storage of work boats that typically carry cement, barite or the like in cargo hold located below deck at the rig site. Once the boat returns to the shore side docks the processed cuttings can be pneumatically or mechanically conveyed or the like and stored in dockside storage 60 until the cuttings are sent for final treatment or disposition.

All measurements disclosed herein are at standard temperature and pressure, at sea level on Earth, unless indicated otherwise. All materials used or intended to be used in a human being are biocompatible, unless indicated otherwise.

Parts List:

process 10

drilling rig 12

body of water 14

drill pipe 16

arrow 18

arrow 20

line 22

shakers 24

lower end 26

trough 28

cuttings convening system 30

conveyer 36

cuttings dryer 38

effluent recovery tank 40

pump 41

decanting centrifuge 42

mud pits 43

pneumatic conveying system 44

return line 45

briquetting system 50

granulating system 52

rig conveying system 54

rig bulk storage area 56

boat bulk storage area 58

dockside storage area 60.

The foregoing embodiments are presented by way of example only; the scope of the present invention is to be limited only by the following claims.

1. A method of treating and shaping drill cuttings for disposal, comprising the following steps:
a. providing initial separation of drilling fluid from the drill cuttings after the drilling fluid is returned from the borehole;
b. drying the drill cuttings in a cuttings dryer;
c. compressing and shaping the cuttings into briquettes;
d. granulating the briquettes into granular material capable of being conveyed pneumatically;
e. conveying the granulated cuttings for transport to a bulk storage boat or to a dockside cuttings disposal site.

2. The method of claim 1, wherein the drill cuttings entering the cuttings dryer contain 20% to 40% or more of oil on cuttings (OOC) ratio of drilling fluids retained on the drill cuttings.

3. The method of claim 1, the cuttings are dried in the cuttings dryer to a moisture content of 1% to 8% total moisture.

4. The method of claim 1, wherein the cuttings are formed into highly compressed, spherical briquettes at a roll force of between 7500 and 65,000 psi.

5. The method of claim 1, wherein the briquettes are granulated to a size in the range of −5 to +50 microns for transport and storage.

6. The method of claim 1, wherein the pelletized cuttings can be transported more readily, and free of hydrocarbon cross-contamination during storage.

7. A system for treating and shaping drill cuttings for disposal, comprising:
a. solids control equipment for separating the cuttings from the drilling fluid returning from a drill string;
b. means for treating the drilling fluid portion for returning the drilling fluid laden with cuttings down into the drill string;
C. a cuttings dryer for reducing the moisture content of the cuttings from a high moisture content down to a range of 1% to 8% total moisture;
d. means for compressing and forming the cuttings into briquettes which are substantially free from surface moisture and cross-contamination for safe transport and storage.

8. The system in claim 7, wherein the cuttings contain 20% to 40% moisture when they enter the cuttings dryer.

9. The system in claim 7, wherein there is further included the step of granulating the cuttings briquettes before storage.

10. The system in claim 7, wherein the cuttings may be stored on a boat or pneumatically conveyed to an onshore facility for storage and/or disposal.

11. The system in claim 7, wherein the means for treating the drilling fluid portion further comprises a effluent recovery tank, decanting centrifuge and mud pits for storing the drilling fluid before it returns down the borehole.

12. The system in claim 7, wherein the means for briquetting the cuttings further comprises a briquetting system which forms the dried cuttings into briquettes at a roll force of between 7500 and 65,000 psi.

13. A method of treating and shaping drill cuttings for disposal, comprising the following steps:
a. providing initial separation of drilling fluid from the drill cuttings after the drilling fluid is returned from the borehole;
b. drying the drill cuttings to reduce the moisture content to 1 to 8% total moisture;
C. compressing and shaping the cuttings into briquettes;
d. granulating the briquettes into granular material capable of being conveyed pneumatically;
14. The method in claim 13 further comprising the step of conveying the granulating the cuttings for transport to a bulk storage boat or to a dockside cuttings disposal site.
